(19) United States
(12) Patent Application Publication
(10) Pub. No.: US 2010/0283960 A1
(43) Pub. Date: Nov. 11, 2010

(54) PENDANT EYEWEAR

(76) Inventor: Daneil Eduardo Berdou, Bueos Aires (AR)

Correspondence Address: Daniel E.Berdou, Paso 784 app.2, Buenos Aires, 10300, AR

(21) Appl. No.: 12/450,910

(22) PCT Filed: Apr. 9, 2008
(86) PCT No.: PCT/IB2008/000915

§ 371 Date: Oct. 19, 2009

(30) Foreign Application Priority Data
Apr. 10, 2007 (NZ) 554357

(51) Int. Cl. G02C 3/00; G02C 5/08

(52) U.S. Cl. 351/156; 351/63

(57) ABSTRACT

An arrangement and usage method for eye-wear, either framed or un-framed, either non-foldable or foldable, for adults and for children. The foldable type enables the lenses to fold outwards, inwards and/or upwards. Both prior art conventional temples are duly replaced by one continuous or sectioned flexible temple with both terminals passing to the eye-wear opposite outer ends, affixed by retaining members. The temple is worn as a necklace holding the eye-wear as a pendant while not in use and partially encircles the head over the ears when fastened by pulling the retaining members. The resulting loose terminals of the fastened temple are consecutively pulled and fixed to releasably secure the eye-wear to the user's head, or either duly shortened to achieve the eye-wear in use position temple length by any appropriate device or mechanism.

The present invention is an arrangement and method of use for eye-wear of all types: eyeglasses for sun and vision correction, safety eye-wear, sports eye-wear and the like.

Prior art eye-wear arrangements are normally composed of a pair of lenses or appropriate substitutes, with or without a frame; a nose bridge portion, foldable or not; two rigid temples somehow foldable and attached to the lenses or lenses frame with downwards curved ends to fit at the back of the ears where they are placed to harness the eye-wear to the user's head.

The mentioned prior art arrangements work substantially well and are extensively used. However they have some drawbacks.

For instance it is difficult to avoid misplacing or loosing the eye-wear, be it for temporary or permanent use. When most needed it might have been placed over the fridge, in the washing machine, in some dark corner beneath the armchair, silently dropped from some pocket or purse, lost or forgotten who knows where. To avoid some of these misfortunes, devices were created for holding the eye-wear by the temples ends to the user's neck. Many types of those devices are widely sold in the market but, besides being quite uncomfortable to wear, stained when eating or crushed when hugged, do not really solve the mentioned problems.

For the same reasons described, prior art eye-wear normally risks being scratched and damaged in many possible ways. Additionally since prior art harnessing is not tight or secure enough, any sudden or inappropriate movement of the head or the body as frequently happens in sports, heavy duties and children playing, will drop the eye-wear, sometimes when most needed. In the case of permanent use, depending on the total weight, the wearer will have more or less discomfort not only on the nose but also at the back of the ears and will need to instinctively develop a somehow prudent physical behavior. Something hard for children to achieve.

This last problem has been relatively solved by some safety, sports and children eye-wear prior art arrangements that are somehow uncomfortable. In most cases the temples are replaced by some kind of tight headband to harness the eye-wear. These bands compress the head when in use and the nape of the neck or the neck when not in use, since the user will keep the eye-wear over the head or tight around the neck in order to quickly wear it if need be.

Some of the advantages of the invention with respect to prior art arrangements are:
The eyewear is carried simply hanging or hanging and kept in a chest pocket, when not in use;
Lesser risk of loosing or damaging the eye-wear;
No effort needed to remember it's whereabouts since it can hardly be misplaced;
The eye-wear at hand when needed;
Much more comfort and safety for permanent use eye-wear as well as lighter and safer fastening to the head;
Much better tightening and fastening to the head when needed;
Cuts off uncomfortable and insecure combinations—extensively used—of rigid temples plus arrangements for holding the eyewear around the neck;
Lighter and easier construction and maintenance;
Much better performance, safety and comfort for people using hearing aids behind the ears together with conventional rigid temples eye-wear;
Much better performance, safety and comfort for children eye-wear.

### DISCLOSURE OF THE INVENTION

The pendant eye-wear, as mentioned above, is an arrangement and usage method for sun, vision correction, sports and safety eye-wear, and the like, either framed or un-framed, either non-foldable or foldable, for adults and for children.

The foldable type has a nose bridge portion joined with one or more, built-in or mounted, butt and/or spring hinges enabling the lenses or substitutes to fold outwards, inwards and/or upwards.

Both prior art conventional temples are duly replaced by one continuous or sectioned flexible temple. Both temple terminals pass through to the eye-wear opposite outer ends, affixed in said positions by retaining members.

The temple may be worn as a necklace holding the eye-wear as a pendant while not in use, and partially encircles the head over the ears when fastened by pulling the retaining members.

The resulting loose terminals of the fastened temple are consecutively pulled and fixed to releasably secure the eye-wear to the user's head, or either duly shortened to achieve the eye-wear in use position temple length by any appropriate device or mechanism.

The one continuous flexible temple is made of any suitable flexible and slender material, wholly or partially elastic or non-elastic, as a thread, cord, ribbon or chain, and the like. It may be adjustable or not and should be long enough to be worn as a necklace comfortably holding the pendant eye-wear. Each of both terminals placed at the eye-wear opposite left and right outer ends, passing through any appropriate attached member and/or any built-in or mounted holes, rings, grooves and the like, or likewise devices and/or mechanisms. Affixed in each of the eye-wear opposite outer ends by retaining members of any desired and suitable shape, size, material, device or mechanism. When magnetic material is chosen for the retaining members, the arrangement may have two, adjustable or not, metal members positioned along the temple to attract the magnetic retaining members when pulled, or vice-versa magnetic members along the temple to attract metal retaining members, in order to achieve the user's desired temple fastening for the eye-wear in use position.

In one of the methods to bring the eye-wear from pendant to the in use position the user first lifts the necklace from the back of the neck forward and place it over the ears keeping the back portion tightened against the nape of the neck. Second pulls left and right, simultaneous and correspondingly, each retaining member in order to lift the pendant eye-wear, concurrently unfolding it if the foldable type is in use, adjusting the temple length and placing the nose bridge in the desired location over the nose.

Finally pulls backwards, over the ears, the resulting loose terminals of the adjusted temple and places the retaining members at the back of each ear, over or below the ear lobes according to the chosen total temple length; or further adjusts and fastens the temple to lock magnetic retaining members to two adjustable attracting metal members positioned along the temple, or vice-versa adjustable magnetic members along the temple to attract metal retaining members; or as may be needed for sports, safety, heavy duties, etc., adjusts and fastens even further a long or elastic enough temple by pulling the loose terminals backwards, over or below the ears, to lock against the nape of the neck both retaining members to each other with, for instance, a magnetic clasp.

### BRIEF DESCRIPTION OF THE DRAWINGS

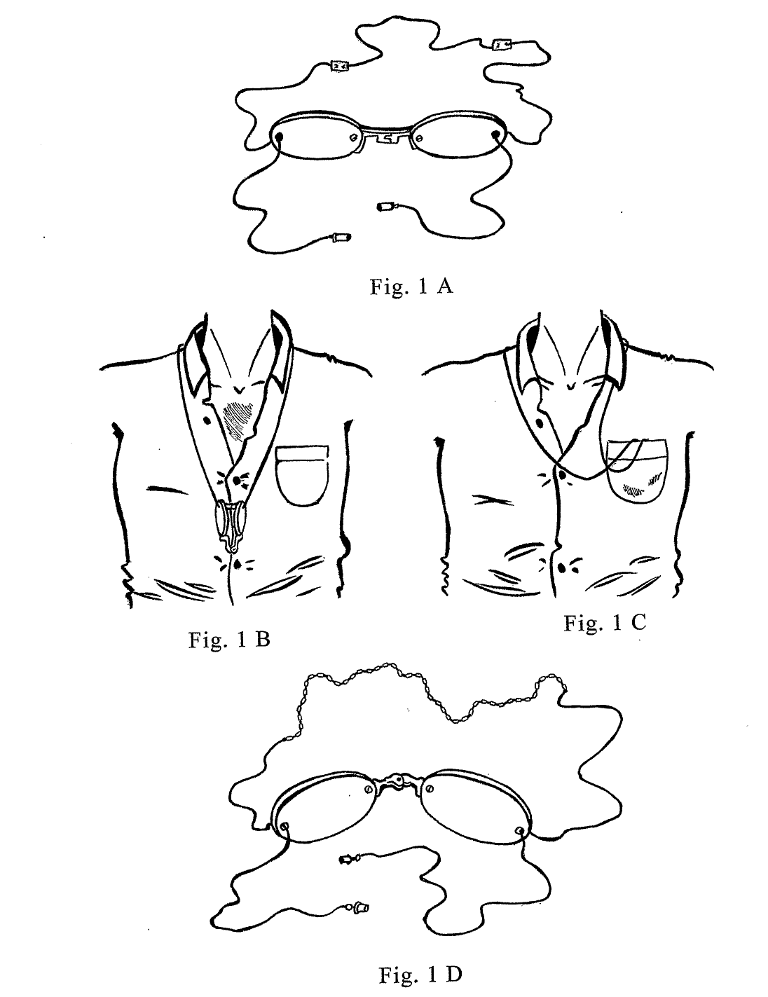

As shown in FIG. 1A (unfolded position) and FIG. 1D (folding position) the eye-wear arrangement is assembled with the following elements or parts: a pair of non framed sample lenses; a foldable nose bridge with a butt hinge mechanism; one 0.7 mm diameter, 900 mm long, continuous flexible temple, made of softly elastic clear silicone thread; two magnetic retaining members placed at the temple terminals, to retain the terminals at the eye-wear opposite outer ends; two 100 mm long, 3 mm wide, 0.03 mm thick, adjustable metal members along the temple back portion suitable to attract the magnetic retaining members; an apportioned hole in each lens opposite end for the temple to smoothly run through them; two supplementary nose support plates.

The arrangement is made in order that the eyewear, with the nose bridge folded outwards by a butt hinge mechanism when not in use, is worn as a pendant hanging against the user's chest as shown in FIG. 1B, or hanging and kept in a chest pocket as shown in FIG. 1C.

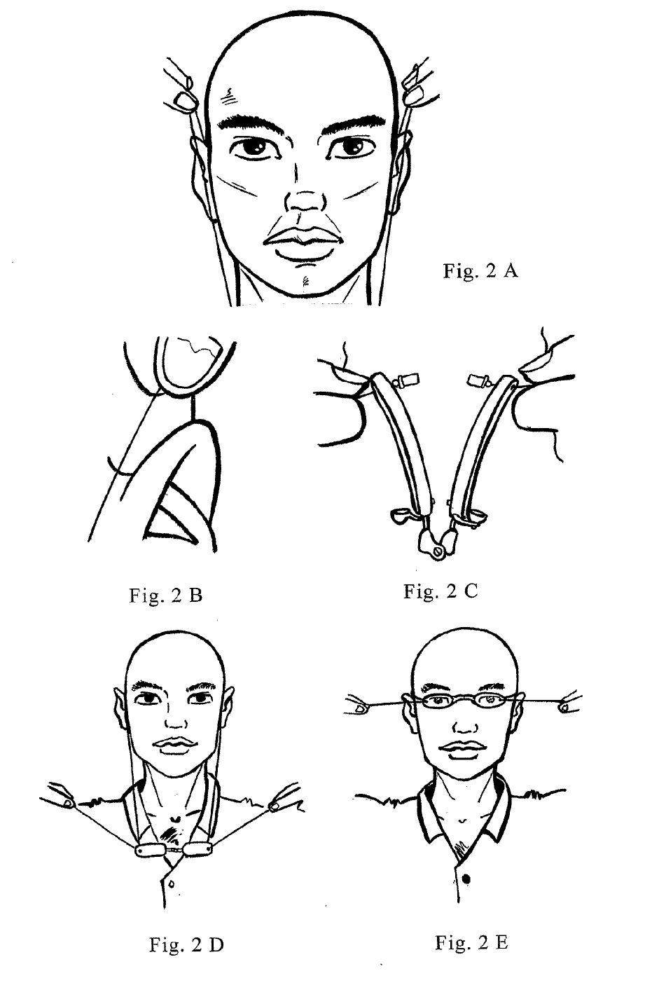

To bring the eye-wear to the in use position the user lifts the temple from the back of the neck forward and place it over the ears tightening the back portion against the nape of the neck as shown in FIG. 2A and the blow up of FIG. 2B. After that step, concurrently unfolding the eye-wear (FIG. 2C), the user pulls left and right, simultaneous and correspondingly, each retaining member passing the temple through the apportioned hole in each lens (FIG. 2D) in order to lift the pendant eye-wear adjusting the temple length and placing the nose bridge in the desired location over the nose (FIG. 2E).

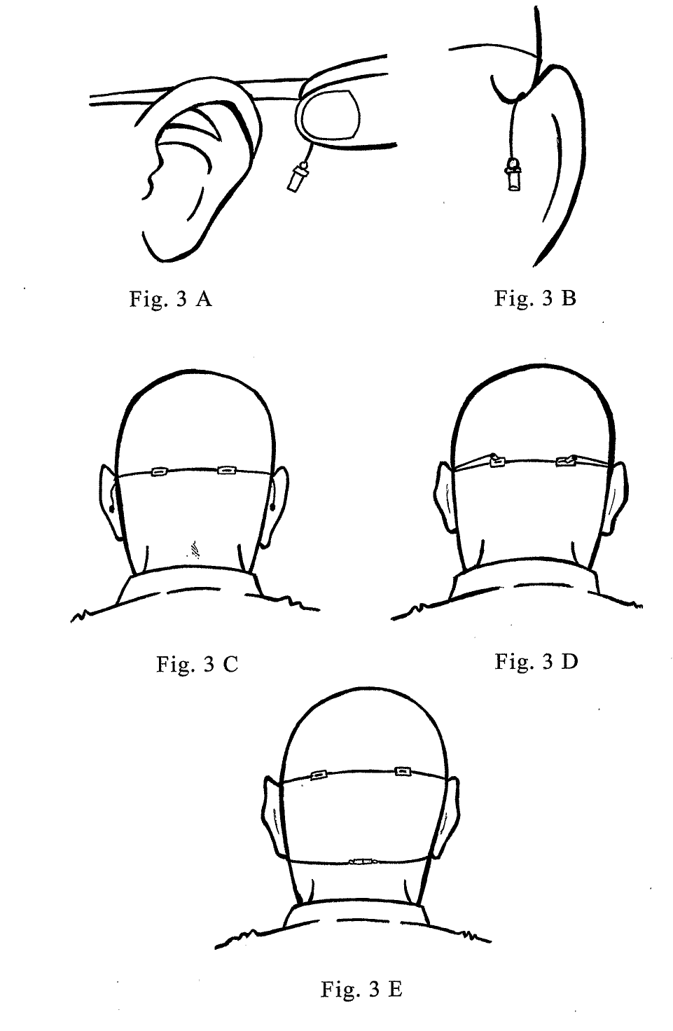

Finally the user pulls backwards, over the ears, the resulting loose terminals of the adjusted temple (FIG. 3A) and places the retaining members at the back of each ear over the ear lobes as shown in the blow up FIG. 3B and FIG. 3C; or further adjusts and fastens the temple to lock the magnetic retaining members to the adjustable attracting metal members positioned along the temple back portion as shown in FIG. 3D; or adjusts and fastens even further the silicone cord elastic temple by pulling the loose terminals backwards, below the ears and locking both magnetic retaining members to each other against the nape of the neck as shown in FIG. 3E.

### BEST MODE FOR CARRYING OUT THE INVENTION

The Pendant Eye-wear innovates on prior art eye-wear arrangements because duly adapts one only continuous or sectioned flexible temple to concurrently carry the eye-wear as a pendant and harness it's use safely and comfortably.

This is rather a structural change with regards to previous arrangements and for this reason there are many possibilities to carry out the invention.

However one embodiment may be the better performer. The one using the folding type eye-wear, either with a butt or spring hinged nose bridge, a continuous flexible temple with magnetic retaining members at the temple terminals and adjustable metal members along the temple back portion to attract the magnetic members, or vice-versa.

For voluminous curved eye-wear lenses, as many sunglasses, safety and sports eye-wear, the hinged nose bridge will perform better if it folds upwards since in that arrangement the upper edges of the lenses or lenses frame will approximate to each other in the folded position. If folded outwards, the lenses convex faces will approximate to each other obstructing a proper folding caused by the lenses volume and curvature. Something similar happens with the inwards folding angle since in the folded position the lenses concave faces will approximate to each other causing voluminous curved lenses to form an uncomfortable ball shape pendant. Moreover the latter will need a very strong nose bridge spring hinge to keep the lenses from folding inwards when in use.

For small vision correction glasses the folding position is not so relevant. Given any preferences the three folding positions can be easily adapted to the user's taste. For this type of eye-wear the air mounted or rimless is the lighter and most elegant.

Modern resilient materials for making lenses allow the nose bridge butt or spring hinge members to be built-in the lenses inner ends, secured with a suitable axial screw or rivet. The passing holes for the flexible temple built in the left and right outer ends of the lenses. It makes a very light and elegant embodiment for reading glasses and sunglasses.

Regarding the continuous flexible temple for obvious reasons a stronger bigger material should be used for bigger and heavier eye-wear.

In small vision correction eye-wear an elastic clear silicone cord temple will perform very well.

In eye-wear for ski, for diving, for swimming or big sunglasses or safety glasses, for instance, the temple will perform better if made of a strong wide ribbon allowing the needed manipulation and tightening

What is claimed is:

1. An arrangement for sun, vision correction, sports and safety eye-wear, and the like, either framed or un-framed, either non-foldable or foldable, collapsible or not, for adults and children use; wherein the foldable type has a nose bridge portion joined with one or more, built-in or mounted, butt and/or spring hinges enabling the lenses or substitutes to fold outwards, inwards and/or upwards; characterized in that both prior art conventional temples are duly replaced by one continuous or sectioned flexible temple; wherein both temple terminals pass through to the eye-wear opposite outer ends, affixed in said positions by retaining members; wherein said temple may be worn as a necklace or strap holding the eye-wear as a pendant while not in use; wherein the temple partially encircles the head over the ears when fastened by pulling the retaining members; wherein the resulting loose terminals of said fastened temple are consecutively pulled and fixed to releasably secure the eye-wear to the user's head, or either duly shortened to achieve the eye-wear in use position temple length by any appropriate device or mechanism.

2. The arrangement of claim 1 characterized in that the one continuous flexible temple is made of any suitable flexible and slender material, wholly or partially elastic or non-elastic, as a thread, cord, ribbon or chain, and the like; it is adjustable or not; it is long enough to be worn as a necklace comfortably holding the said pendant eye-wear; with each of both terminals placed at the eye-wear opposite left and right outer ends, passing through any appropriate attached members and/or any built-in or mounted holes, rings, grooves and the like, or likewise devices and/or mechanisms; affixed in each of the eye-wear opposite outer ends by retaining members of any desired and suitable shape, size, material, device or mechanism. When magnetic material is chosen for the retaining members, the arrangement may have two, adjustable or not, metal members positioned along the temple to attract the magnetic retaining members when pulled, or vice-versa magnetic members along the temple to attract metal retaining members, in order to achieve the user's desired temple fastening for the eye-wear in use position.

3. The arrangement of claim 1 characterized in that the one flexible temple is made and assembled in sections; wherein all or some sections are made of any suitable flexible and slender material, wholly or partially elastic or non-elastic, as a thread, cord, ribbon or chain, and the like; wherein one or more sections are not flexible; wherein at least one section, preferably the back portion of the temple, is flexible; wherein two sections, preferably the temple terminals, are flexible; wherein the non flexible sections are made from any suitable material of any shape and size; wherein the sections are joined in any suitable way like threading or sewing or by any suitable member or members passing through either built-in or mounted holes, rings, grooves and the like, or likewise devices and/or mechanisms; wherein the flexible and/or non flexible sections may have additional terminals as well as retaining members and ear protection devices, enabling the temple to have variant combinations for bringing the eye-wear from pendant to the in use position.

4. A usage method to bring the eye-wear arrangement of claim 1 from pendant to the in use position, characterized in that the user:
a. Lifts with the fingers the temple from the back of the neck forward and places it over the ears (FIG. 2A and FIG. 2B) keeping the back portion tightened against the nape of the neck;
b. Pulls left and right, simultaneous and correspondingly, each retaining member passing the temple smoothly through the appropriate apportioned space in each of the eyewear opposite ends in order to lift the pendant eye-wear (FIG. 2D), concurrently unfolding it if the foldable type is in use (FIG. 2C), adjusting the temple length and placing the nose bridge in the desired location over the nose (FIG. 2E) or it's tip for reading glasses;
c. Pulls backwards, over the ears, the resulting loose terminals of the adjusted temple (FIG. 3A) and places the retaining members loose at the back of each ear, over (FIG. 3B and FIG. 3C) or below the ear lobes according to the chosen total temple length; or further adjusts and fastens the temple terminals over or below the ears locking magnetic retaining members to adjustable attracting metal members positioned along the temple (FIG. 3D) or clasping the retaining members (FIG. 3E); or vice-versa adjustable magnetic members along the temple to attract metal retaining members; or as may be needed for sunglasses, sports, safety, heavy duties, etc., adjusts and fastens even further a long or elastic enough temple by pulling the loose terminals backwards, over or below the ears, to lock against the nape of the neck both retaining members to each other with, for instance, a magnetic clasp, a knot or velcro type stripes and/or any desired and suitable shape, size, material, device or mechanism used for the retaining members; or duly shortens the temple length to achieve the eye-wear in use position temple length by effect of any appropriate device or mechanism, as a spring reel.

5. A usage method to bring the eye-wear arrangement of claim 1 from pendant to the in use position, characterized in that the user:
a. From the pendant position lifts with the fingers the eye-wear by the temple inner ends, concurrently unfolding the eyewear if the foldable type is in use, and places the nose bridge in the desired location over the nose as if for a quick look;
b. Pulls backwards simultaneously over the ears the temple inner ends;
c. For further tightening pulls left and right, correspondingly, each retaining member passing the temple smoothly through the appropriate apportioned space in of the eyewear opposite ends in order to adjust the temple length until the back portion is tightened against the nape of the neck;
d. Pulls backwards, over the ears, the resulting loose terminals of the adjusted temple and places the retaining members loose at the back of each ear, over or below the ear lobes according to the chosen total temple length; or further adjusts and fastens the temple terminals over or below the ears locking magnetic retaining members to adjustable attracting metal members positioned along the temple or clasping the retaining members; or vice-versa adjustable magnetic members along the temple to attract metal retaining members; or as may be needed for sunglasses, sports, safety, heavy duties, etc., adjusts and fastens even further a long or elastic enough temple by pulling the loose terminals backwards, over or below the ears, to lock against the nape of the neck both retaining members to each other with, for instance, a magnetic clasp, a knot or velcro type stripes and/or any desired and suitable shape, size, material, device or mechanism used for the retaining members; or duly shortens the temple length to achieve the eye-wear in use position temple length by effect of any appropriate device or mechanism, as a spring reel.

6. A usage method to bring the eye-wear arrangement of claim 1 from pendant to the in use position, characterized in that the user is able to place the nose bridge in the desired location over the nose tightening and fastening the temple to the desired in use position by any suitable section terminals and retaining members combination that joined non flexible and/or flexible temple sections may possibly permit; wherein any steps the user may follow to harness the continuous or sectioned flexible temple will finally bring the eye-wear from pendant to the in use position, by placing the nose bridge in the desired location over the nose and fastening the temple to the desired tightened and fastened in use position.
